(19) United States
(12) Patent Application Publication
(10) Pub. No.: US 2011/0109804 A1
(43) Pub. Date: May 12, 2011

(54) MOTION ESTIMATION DEVICE AND MOTION ESTIMATION SYSTEM WITH PIPELINE ARCHITECTURE

(75) Inventors: Chih-Hung WENG, Kaohsiung City (TW); Sheng-De Wang, Taipei City (TW)

(73) Assignee: National Taiwan University, Taipei City (TW)

(21) Appl. No.: 12/822,125

(22) Filed: Jun. 23, 2010

(30) Foreign Application Priority Data
Nov. 9, 2009 (TW) 98137974

(51) Int. Cl. H04N 5/14

(52) U.S. Cl. 348/699; 348/E05.062

(57) ABSTRACT

A motion estimation device with pipeline architecture is provided, which includes a processing unit array and a motion vector generation unit. The processing unit array generates a number of match values, each of which indicates the match degree between a current block and a corresponding reference block. The processing unit array includes a number of data fetching units and processing units. The data fetching units each are for fetching a number of current data of the current block and a number of reference data of the corresponding reference block. The processing units are coupled to the data fetching unit correspondingly, and each for processing the current data and the corresponding reference data, so as to generate the match values. According to the match values, the motion vector generation unit is for generating a motion vector between the current block and a reference block which corresponds to optimum match degree.

This application claims the benefit of Taiwan application Serial No. 98137974, filed Nov. 9, 2009, the subject matter of which is incorporated herein by reference.

### BACKGROUND OF THE APPLICATION

1. Field of the Application

The application relates in general to an estimation device and an estimation system, and more particularly to a motion estimation device and a motion estimation system with pipeline architecture.

2. Description of the Related Art

Motion estimation plays an important role in the application of multimedia. The estimation of motion vector is usually achieved by a processing unit array. The processing unit array searches a number of reference blocks contained in a search region for one reference block that best matches a current block. Therefore, it is possible to estimate the motion vector according to the current block and the reference block.

The processing unit array may include a number of processing units, whose number of required processing units is associated with the size of the current block. The processing units are used to calculate a sum of absolute difference between a number of pixel data of the current block and each reference block. In general, a smaller sum of absolute differences indicates that the match degree between the current block and the reference block is better.

In a conventional motion estimation device, 16 processing units are required to deal with 4×4 current block. In the course of calculating the sum of absolute differences between a number of pixel data of the current block and a reference block, a first processing unit calculates the absolute difference between a first piece of current data of the current block and a first piece of reference data of the reference block, while a second processing unit calculates the absolute difference between a second piece of current data of the current block and a second piece of reference data of the reference block, which can be derived analogically. In addition, at least some of the processing units which are adjacent to each other can be connected with each other for delivering the calculation results, so as to accumulate the absolute differences. In this way, it is practicable to calculate the sum of absolute differences between the current block and a corresponding reference block. Next, the motion estimation device selects a reference block that corresponds to minimum sum of absolute differences, which it uses to determine the motion vector.

However, in the conventional motion estimation device, a reference block requires to be processed by several processing units, such as 16 processing units, for generating its sum of absolute differences, and the processing units are required to be connected with each other for delivering the calculation results. Therefore, the motion estimation device is not only required of long time for calculation, but also influenced by wide area of processing units, large number of processing units, and circuit complexity of interconnection. For example, a conventional motion estimation device requires 16 processing units to deal with a 4×4 current block. Moreover, as the image resolution increases, the computation complexity of the motion estimation device is enlarged significantly. At this time, system efficiency will be reduced if conventional architecture is adopted to perform image compression.

### SUMMARY OF THE APPLICATION

The application is directed to a motion estimation device and a motion estimation system with pipeline architecture, which allows each processing unit to deal with the data of a current block and a corresponding reference block, thereby saving the interconnection between the processing units, and reducing the circuit complexity and required area. Moreover, it is also possible to prevent the calculation results from being delivered between the processing units, so as to reduce the required time for estimation.

According to a first aspect of the present application, a motion estimation device with pipeline architecture is provided, which includes a processing unit array and a motion vector generation unit. The processing unit array is for generating a number of match values, and each match value indicates the match degree between a current block and a corresponding reference block. The processing unit array includes a number of data fetching units and a number of processing units. The data fetching units each are for fetching a number of current data of the current block and a number of reference data of the corresponding reference block. The processing units are coupled to the data fetching unit correspondingly, and each for processing the current data and the corresponding reference data, so as to generate the match values. According to the match values, the motion vector generation unit is for generating a motion vector between the current block and a reference block which corresponds to optimum match degree.

According to a second aspect of the present application, a motion estimation system with pipeline architecture is provided, which comprises a first processing unit array, a second processing unit array, a combination unit, and a motion vector generation unit. The first processing unit array is for generating a number of first match values, and each of the first match values indicates the match degree between a first current block and a corresponding first reference block. The second processing unit array is for generating a number of second match values, and each of the second match values indicates the match degree between a second current block and a corresponding second reference block. The second current block is adjacent to the first current block, and the corresponding first reference block is adjacent to the corresponding second reference block. The combination unit is for generating a number of combination values according to the corresponding sums of the first match values and the second match values. Each of the combination values indicates the match degree between a combination current block and a corresponding combination reference block. The combination current block contains the first current block and the second current block which are adjacent to each other, and the combination reference block contains the first reference block and the second reference block which are adjacent to each other. The motion vector generation unit is for generating a motion vector from the combination current block and a combination reference block which corresponds to optimum match degree according to the combination values.

The application will become apparent from the following detailed description of the preferred but non-limiting embodiments. The following description is made with reference to the accompanying drawings.

### BRIEF DESCRIPTION OF THE DRAWINGS

FIG. 1 is a block diagram showing a motion estimation device with pipeline architecture according to an embodiment of the application;

FIG. 2 is a block diagram showing an example of the processing unit array of the motion estimation device in FIG. 1;

FIGS. 3A to 3C are schematic diagrams showing examples of a current block, a search region, and a number of reference blocks contained in the search region, respectively, which are used in the motion estimation device with pipeline architecture in FIG. 1;

FIG. 4 is a schematic diagram showing an example of the data stream of the motion estimation device with pipeline architecture in FIG. 1;

FIG. 5 is a block diagram showing an example of the processing unit of the motion estimation device with pipeline architecture in FIG. 1;

FIG. 6 is a block diagram showing an example of the motion vector generation unit of the motion estimation device with pipeline architecture in FIG. 1;

FIG. 7 is a block diagram showing a motion estimation system with pipeline architecture according to an embodiment of the application;

FIGS. 8A to 8C are schematic diagrams showing another examples of a current block, a search region, and a number of reference blocks contained in the search region, respectively, which are used in the motion estimation device with pipeline architecture in FIG. 1.

### DETAILED DESCRIPTION OF THE APPLICATION

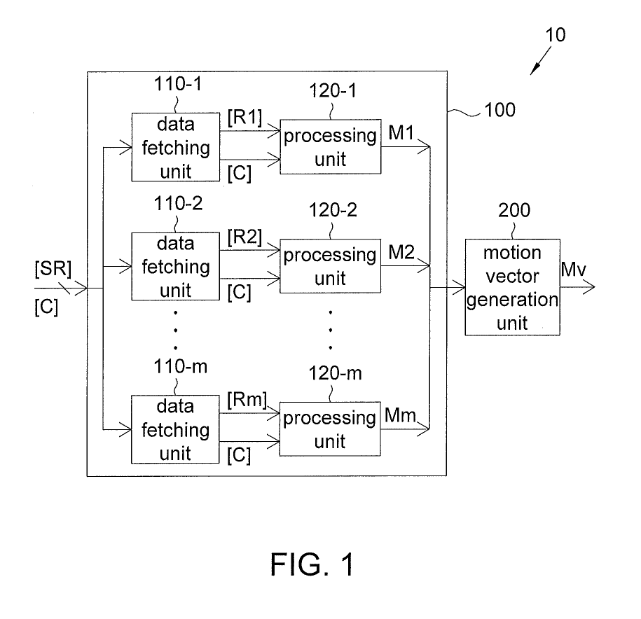

FIG. 1 is a block diagram showing a motion estimation device with pipeline architecture according to an embodiment of the application. The motion estimation device with pipeline architecture 10 includes a processing unit array 100 and a motion vector generation unit 200. The processing unit array 100 is for generating a number of match values M1 to Mm, and each match value indicates the match degree between a current block and a corresponding reference block. According to the match values M1 to Mm, the motion vector generation unit 200 is for generating a motion vector My between the current block and a reference block which corresponds to optimum match degree.

As shown in FIG. 1, the processing unit array 100 includes, for example, a number of data fetching units 110-1 to 110-m and a number of processing units 120-1 to 120-m. The data fetching units 110-1 to 110-m each are for fetching a number of current data [C] of the current block and a number of reference data [R1] to [Rm] of the corresponding reference block. In other words, according to the current data [C] and the reference data [SR] of a search region, the processing unit array 100 of the embodiment causes the data fetching unit 110-1 to fetch the current data [C] of the current block and the reference data [R1] of a corresponding reference block, the data fetching unit 110-2 to fetch the current data [C] of the current block and the reference data [R2] of another corresponding reference block, . . . , and the data fetching unit 110-m to fetch the current data [C] of the current block and the reference data [Rm] of another corresponding reference block.

The processing units 120-1 to 120-m are coupled to the data fetching unit 110-1 to 110-m correspondingly. The processing units 120-1 to 120-m each are for dealing with the current data [C] and the corresponding reference data [R1] to [Rm], so as to generate the match values M1 to Mm, respectively. Therefore, as compared with a conventional approach in which processing units are connected to each other for delivering calculated results, the embodiment allows each processing unit to deal with the data of a current block and a corresponding reference block, thereby saving the interconnection between the processing units, and reducing the circuit complexity and required area. Moreover, because each of the processing units can deal with data individually, it is also possible to prevent the calculation results from being delivered between the processing units, which reduces the required time for estimation.

In an embodiment of the motion estimation device with pipeline architecture 10, the current block and the reference block each can have a dimension of n×n, the number of the data fetching units can be n+1, and the number of the processing units can be n+1. An example, in which n is 4, is made to illustrate how the data fetching unit fetches the required current data and the reference data for the processing units, to which, however, the application is not limited.

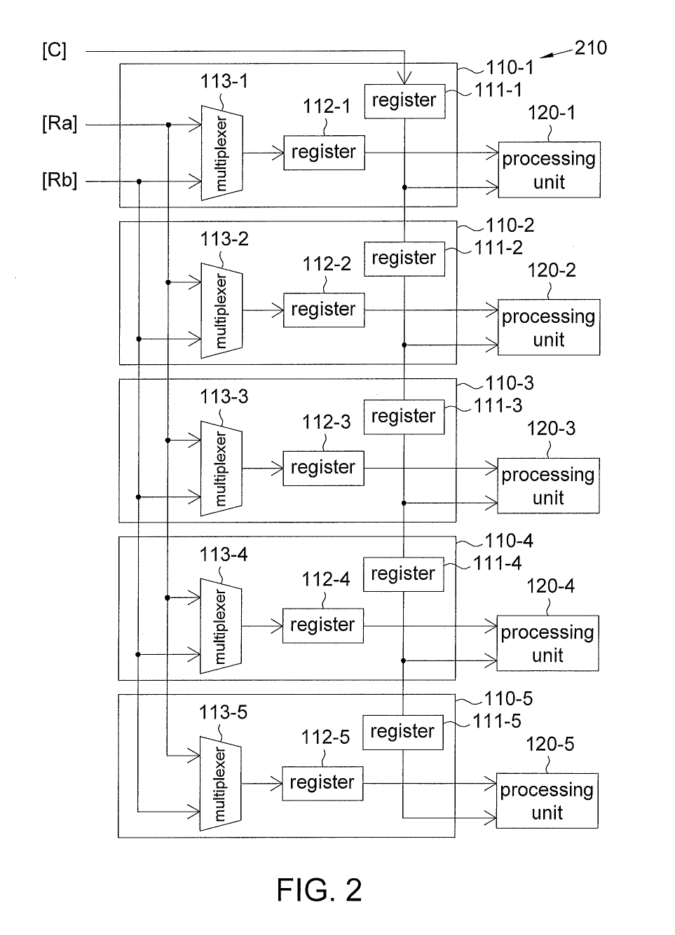

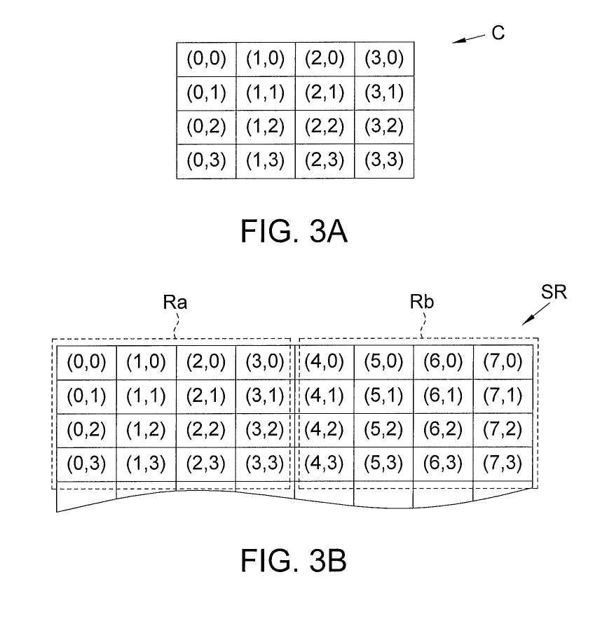

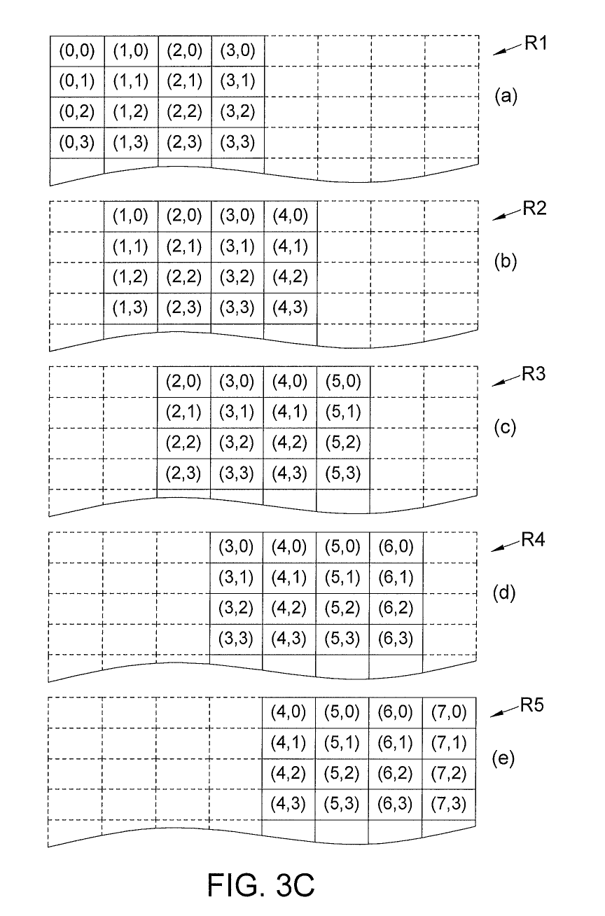

Refer to FIGS. 2 to 4. FIG. 2 is a block diagram showing an example of the processing unit array of the motion estimation device in FIG. 1. FIGS. 3A to 3C are schematic diagrams showing examples of a current block, a search region, and a number of reference blocks contained in the search region, respectively, which are used in the motion estimation device with pipeline architecture in FIG. 1. FIG. 4 is a schematic diagram showing an example of the data stream of the motion estimation device with pipeline architecture in FIG. 1.

As shown in FIG. 2, the processing unit array 210 includes 5 data fetching units 110-1 to 110-5 and 5 processing units 120-1 to 120-5. Each data fetching unit includes a first register, a second register, and a multiplexer. In other words, the data fetching units 110-1 to 110-5 include first registers 111-1 to 111-5, second registers 112-1 to 112-5, and multiplexers 113-1 to 113-5, respectively.

As shown in FIGS. 3A to 3C, the current block C has a dimension of 4×4, and includes 16 pieces of current data [C], wherein [C]=C(0,0) to C(3,3). In this example, the search region SR has a width twice the width of the current block C, i.e. a width of 8, wherein the reference data [SR]=R(0,0) to R(7,3). The search region SR includes two predetermined reference regions Ra and Rb that are adjacent to each other, and each of the predetermined reference regions Ra and Rb has a width half the width of the search region SR, i.e. a width of 4. In the search region SR, 5 reference blocks R1 to R5 can be obtained from the predetermined reference block Ra to the predetermined reference block Rb, as shown in FIGS. 3C(a) to (e). The reference blocks R1 to R5 each also have a dimension of 4×4, and each include 16 pieces of current data [R1] to [R5], wherein [R1]. R(0,0) to R(3,3), [R2]=R(1,0) to R(4,3), [R3]=R(2,0) to R(5,3), [R4]=R(3,0) to R(6,3), and [R5]=R(4,0) to R(7,3). As shown in FIGS. 3B and 3C, the two predetermined reference blocks Ra and Rb can be, for example, the two reference blocks R1 and R5 to be processed by the processing units 120-1 and 120-5.

Referring to both FIGS. 2 and 4, the 16 pieces of current data [C]=C(0,0) to C(3,3) of the current block C are sequentially fed into the data processing unit 210. The first register 111-1 sequentially stores the current data [C]=C(0,0) to C(3,3) of the current block C, and is coupled to the first register of another data fetching unit, such as the first register 111-2 of data fetching unit 110-2. The first register 111-1 transmits the current data [C]=C(0,0) to C(3,3) which is delayed by one clock cycle to the first register 111-2. In this way, the processing unit 120-1 receives the current data [C]=C(0,0) to C(3,3) at clock cycles 1 to 16, and processing unit 120-2 receives current data [C]=C(0,0) to C(3,3) at clock cycles 2 to 17. As can be derived, by using the first registers 111-1 to 111-5 to delay the current data [C], the current data [C]=C(0,0) to C(3,3) of the first registers 111-1 to 111-5 provided to the processing units 120-1 to 120-5 are sequentially delayed by one clock cycle, as shown in FIG. 4.

Correspondingly, the 16 pieces of data [R1]. R(0,0) to R(3,3) of the reference block Ra are also sequentially fed into the data processing array 210. The 16 pieces of data [R5]=R(4,0) to R(7,3) of the reference block Rb are delayed by 4 clock cycles and sequentially fed into the data processing array 210, i.e. the data [R1] of the reference block Ra 4 are lagged behind the data [R5] of the reference block Rb by 4 clock cycles, As to the data fetching unit 110-1, the multiplexer 113-1 selectively delivers two pieces of reference data [Ra] and [Rb] of two predetermined reference blocks Ra and Rb, which allows the second register 112-1 to sequentially store the reference data [R1] of the reference block R1 for the processing unit 120-1. Similarly, as to the data fetching units 110-2 to 110-5, the multiplexers 113-2 to 113-5 are such performed that the second registers 112-2 to 112-5 can sequentially store the reference data [R2] to [R5] of the reference blocks R2 to R5 for the processing units 120-2 to 120-5. In this way, the second registers 112-1 to 112-5 can provide the corresponding reference data [R1] to [R5], wherein [R1]=C(0,0) to C(3,3), . . . , [R5]=C(4,0) to C(7,3), as shown in FIG. 4.

As such, the processing units 120-1 to 120-5 each can deal with the current data [C] and a corresponding one of the reference data [R1] to [R5]. In other words, the processing unit 120-1 deals with the current data [C]=C(0,0) to C(3,3) of the current block C and the corresponding reference data [R1]. R(0,0)˜R(3,3) of the reference block R1; the processing unit 120-2 deals with the current data [C]=C(0,0) to C(3,3) of the current block C and the corresponding reference data [R2]=R(1,0)˜R(4,3) of the reference block R1; other processing units 120-3 to 120-5 are preformed in a similar manner which can be derived with reference to above-related description and will not be specified for the sake of brevity.

The embodiment uses the first registers 111-1 to 111-5 to delay current data and properly controls the multiplexers 113-1 to 113-5 to transmit reference data, which improves the usage of data in a repetitive manner. Moreover, as to a 4×4 current block, the number of required processing unit is 16 for conventional motion estimation device, but 5 (5=4+1) for the embodiment as shown in FIG. 2. Thus, the embodiment can efficiently reduce the number of required circuit elements. Moreover, if the image resolution increases to the extent that the current block has a dimension of n×n, the number of required processing unit is the square of n for conventional motion estimation device, while n+1 for the embodiment. Therefore, the motion estimation device of the embodiment has lower computation complexity than conventional motion estimation device has.

Moreover, it can be seen from FIG. 4 that when the embodiment deals with the 4×8 search region R, the processing time is 16+4=20 clock cycles, wherein 4 of them are used to fill data in the processing unit array of the motion estimation device with pipeline architecture. Thus, if the dimension of the search regions R increases to 16×8, the processing time is 16×5+4=84 clock cycles only. Those skilled in the art can acknowledge that the embodiment has advantages of high processing speed and high system efficiency. Furthermore, because a number of registers are used to transmit to-be-processed data, the circuit of the embodiment can be performed with reduced logical delays, so that the motion estimation device with pipeline architecture 10 can be operated at a higher-speed clock.

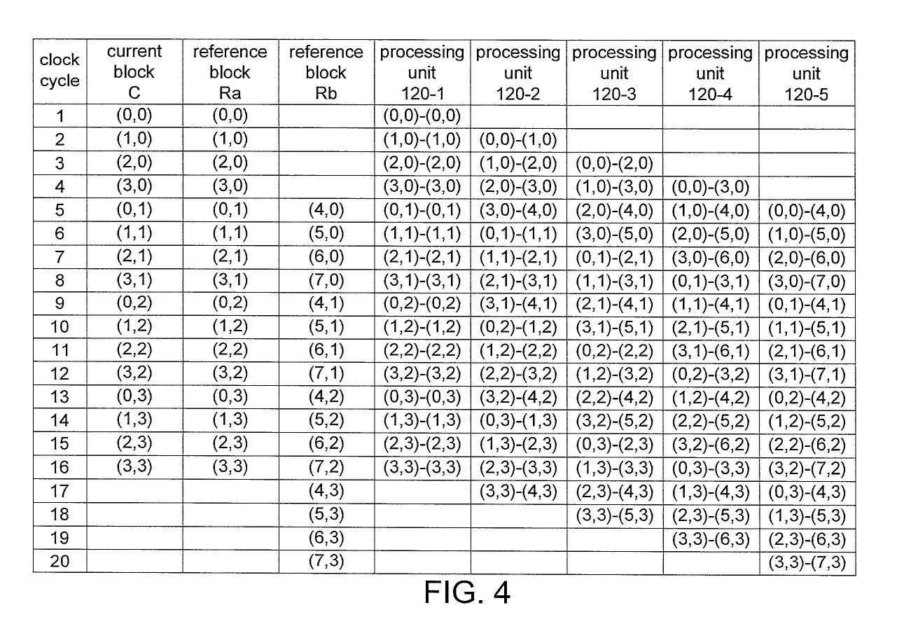

In an embodiment, as to the current block and a corresponding reference block, the match value is the sum of absolute differences between the current data and the corresponding reference data. At this time, each processing unit can be implemented as the one shown in FIG. 5.

FIG. 5 is a block diagram showing an example of the processing unit of the motion estimation device with pipeline architecture in FIG. 1. The processing unit shown in FIG. 5 is illustrated as an example of the processing unit 120-1. The processing unit 120-1 includes a subtractor 121-1 and an adder 122-1. The subtractor 121-1 receives the current data [C] and the reference data [R1], and calculates an absolute difference AD1 between a piece of current data and a piece of reference data. The adder 122-1 accumulates the calculated results of the subtractor 121-1 so as to generate the sum of absolute differences SAD1. The processing unit 120-1 includes, for example, two registers 123-1 and 124-1 which are deposited on the output side of the subtractor 121-1 and the adder 122-1. Then, the processing unit 120-1 serves the sum of absolute differences SAD1 as the match values M1, and output it to the motion vector generation unit 200.

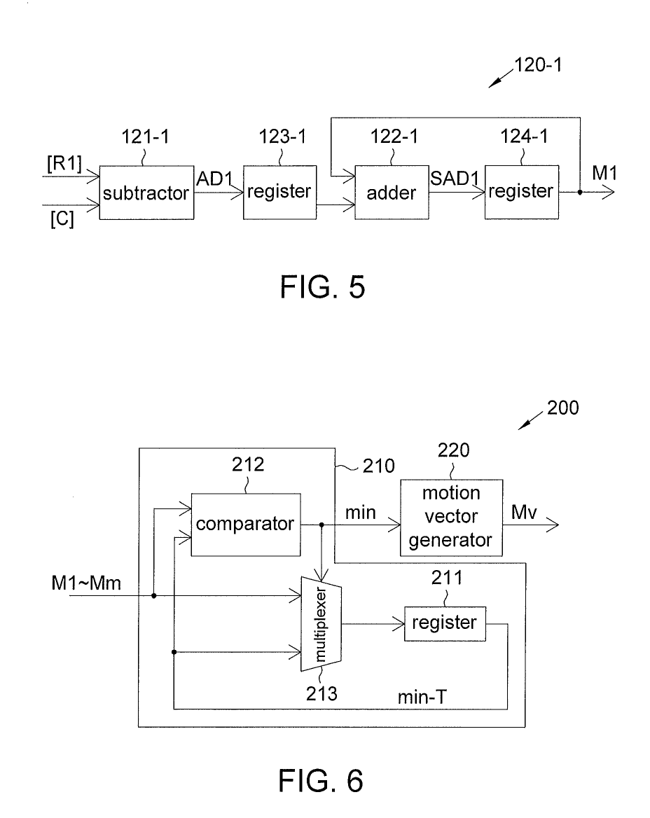

FIG. 6 is a block diagram showing an example of the motion vector generation unit of the motion estimation device with pipeline architecture in FIG. 1. The motion vector generation unit 200 includes a comparison circuit 210 and a motion vector generator 220. The comparison circuit 210 obtains a minimum value min from the match values M1 to Mm. The motion vector generator 220 generates the motion vector My according to the comparison results of the comparison circuit 210.

For example, as shown in FIG. 6, the comparison circuit 210 includes a register 211, a comparator 212, and a multiplexer 213. The register 211 stores a temporary minimum value min-T. The comparator 212 compares the temporary minimum value min-T with one of the match values M1 to Mm. The multiplexer 213 provides the minor one between the temporary minimum value min-T and the one of the match values M1 to Mm to the register 211 according to comparison result of the comparator 212, so as to update the stored content of the register 211. In this way, the minimum value min can be obtained after the comparison of the match values M1 to Mm has completed.

The motion vector generator 220 includes, for example, a counter (not shown) for calculating the distances of x and y between the current block and the reference block which corresponds to optimum match degree by means of counting. For example, the temporary minimum value min-T can be initially configured as a maximum value. Then, after the match values M1 to Mm are received, if the comparator 212 obtains that a match value of a processing unit is less than the temporary minimum value min-T, the comparator 212 triggers the multiplexer 213 to store said match value in the register 211 for subsequent comparison. In this situation, the comparator 212 also triggers the motion vector generator 220 to determine the relative values of x-axis and y-axis by means of counting. After iterative computation, it is possible to obtain the values indicative of the distances along x-axis and y-axis, respectively, which can be used to generate the motion vector Mv.

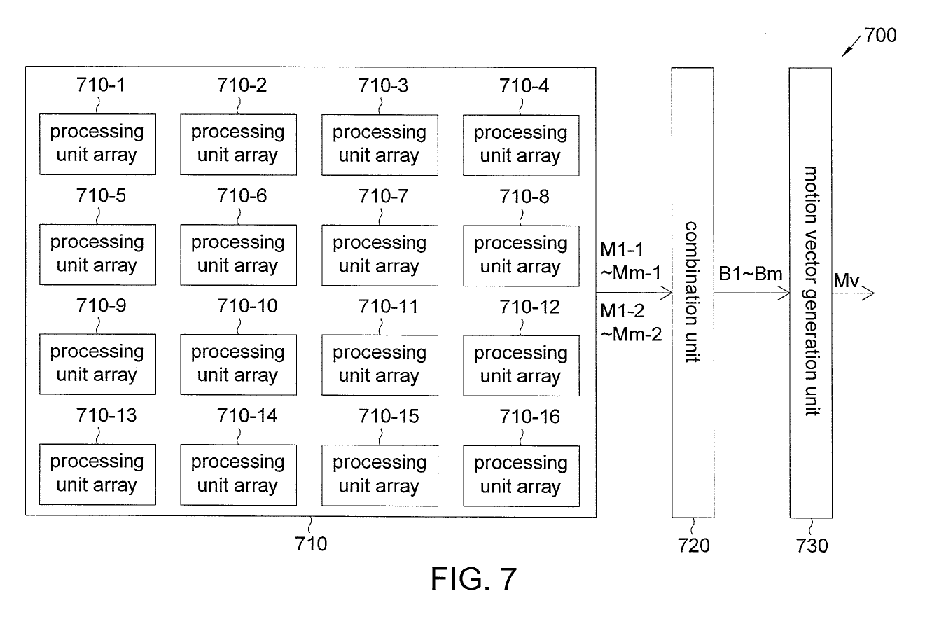

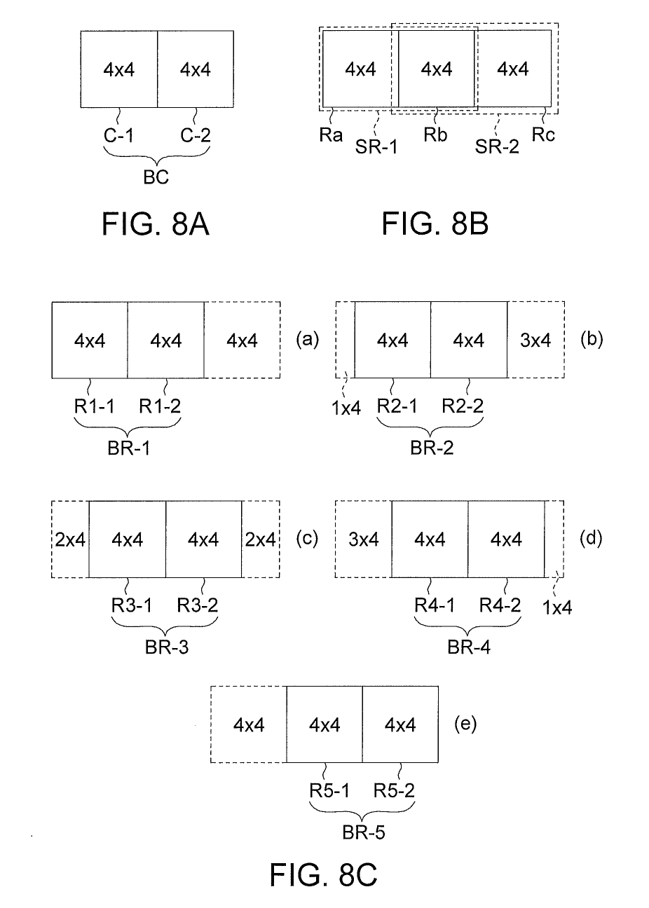

Besides, the application further provides a motion estimation system with pipeline architecture to which the motion estimation device with pipeline architecture in FIG. 1 is applied. Refer to FIG. 7 and FIGS. 8A to 8C. FIG. 7 is a block diagram showing a motion estimation system with pipeline architecture according to an embodiment of the application. FIGS. 8A to 8C are schematic diagrams showing another examples of a current block, a search region, and a number of reference blocks contained in the search region, respectively, which are used in the motion estimation device with pipeline architecture in FIG. 1.

As shown in FIGS. 8A and 8B, the current blocks C-1 and C-2 are exemplified as having a dimension of 4×4, and each of the search regions SR-1 and SR-2 has a width twice the width of each of the current blocks C-1 and C-2, i.e. a width of 8. The search region SR-1 includes two predetermined reference regions Ra and Rb, and each of the predetermined reference regions Ra and Rb has a width half the width of the search region SR-1, i.e. a width of 4. In the search region SR-1, 5 4×4 reference blocks R1-1 to R5-1 can be obtained from the predetermined reference block Ra to the predetermined reference block Rb, as shown in FIG. 8C. Similarly, in the search region SR-2, 5 4×4 reference blocks R1-2 to R5-2 can be obtained from the predetermined reference block Rb to the predetermined reference block Rc, as shown in FIG. 8C.

The motion estimation system with pipeline architecture 700 includes a first processing unit array 710-1 and a second processing unit array 710-2. Each of the processing unit arrays 710-1 and 710-2 can be, for example, implemented as the processing unit array 100 shown in FIG. 1.

The first processing unit array 710-1 is for generating a number of first match values M1-1 to Mm-1, and each of the first match values M1-1 to Mm-1 indicates the match degree between a first current block C-1 and a corresponding one of the first reference blocks R1-1 to R5-1. The second processing unit array 710-2 is for generating a number of second match values M1-2 to Mm-2, and each of the second match values M1-2 to Mm-2 indicates the match degree between a second current block C-2 and a corresponding one of the second reference block R1-2 to R5-2. The second current block C-2 is adjacent to the first current block C-1, and the corresponding one of the first reference block R1-1 to R5-1 is adjacent to the corresponding one of the second reference block R1-2 to R5-2.

The combination unit 720 is for generating a number of combination values B1 to Bm according to the corresponding sums of the first match values M1-1 to Mm-1 and the second match values M1-2 to Mm-2. Each of the combination values B1 to Bm indicates the match degree between a combination current block BC and a corresponding combination reference block. The combination current block BC contains the first current block C-1 and the second current block C-2 which are adjacent to each other, and the combination reference block contains a first reference block and a second reference block which are adjacent to each other. As shown in FIG. 8C, the combination reference block BR in this example can be selected from five combination reference blocks BR-1 to BR-5, which include a corresponding one of the first reference blocks R1-1 to R5-1 and a corresponding one of the second reference blocks R1-2 to R5-2, respectively.

The motion vector generation unit 730 is for generating a motion vector My from the combination current block and a combination reference block which corresponds to optimum match degree according to the combination values B1 to Bm, which can be derived similarly with reference to the motion vector generation unit 200 in FIG. 1 and will not be specified for the sake of brevity. Hence, as compared with a conventional approach in which processing units are connected to each other, the embodiment allows the combination unit 720 to determine how to merging the outputs, i.e. match values, of the processing unit arrays together, thereby further reducing the circuit complexity and required area.

While two processing unit arrays are provided as an exemplary embodiment for illustration, it is to be understood that the application is not limited thereto. As shown in FIG. 8, the motion estimation system with pipeline architecture 800 can further include more processing unit arrays, such as 16 processing unit arrays 710-1 to 710-16. The 16 processing unit arrays 710-1 to 710-16 can be integrated into a processing unit array module 710. The 16 processing unit arrays 710-1 to 710-16 are for generating several groups of match values (not shown). The combination unit 720 is for generating a number of combination values B1 to Bm according to the corresponding sums of those groups of match values. In this example, the combination current block BC includes a number of adjacent current blocks, and the combination reference block includes a number of adjacent reference blocks, which can be derived similarly with reference to above-related description and will not be specified for the sake of brevity. Therefore, the embodiment allows the combination unit to determine how to merge the match values of the processing unit arrays together, which provides users with much more kinds of block combination as to meet different coding requirements.

The motion estimation device and motion estimation system with pipeline architecture can be implemented in digital video decoder, and the implementation can be adjusted according to the dimension of the to-be-searched current block. It can be obtained that the motion estimation device and motion estimation system with pipeline architecture of the embodiment can be applied to those video coding standards with block-based motion estimation, such as the standard of moving picture experts group (MPEG), H.264, or other video coding standards available in the art.

According to the present embodiments of the application, the motion estimation device and motion estimation system with pipeline architecture allow each processing unit to deal with the data of a current block and a corresponding reference block, which is capable of saving the interconnection between the processing units, and reducing the circuit complexity and required area. Moreover, because each of the processing units can deal with data individually, it is also possible to prevent the calculation results from being delivered between the processing units, so as to reduce the required time for estimation.

While the application has been described by way of example and in terms of a preferred embodiment, it is to be understood that the application is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A motion estimation device with pipeline architecture, comprising:
a processing unit array for generating a plurality of match values, each of the match values indicating the match degree between a current block and a corresponding reference block, the processing unit array comprising:
a plurality of data fetching units, each for fetching a plurality of current data of the current block and a plurality of reference data of the corresponding reference block; and
a plurality of processing units coupled to the data fetching unit correspondingly, each for processing the current data and the corresponding reference data, so as to generate the match value; and
a motion vector generation unit for generating a motion vector from the current block and a reference block which corresponds to optimum match degree according to the match values.

2. The motion estimation device with pipeline architecture according to claim 1, wherein the current block and the reference block each have a dimension of n×n, the number of the data fetching units is n+1, and the number of the processing units is n+1.

3. The motion estimation device with pipeline architecture according to claim 2, wherein n is 4.

4. The motion estimation device with pipeline architecture according to claim 1, wherein each of the data fetching units comprises:
a multiplexer for selectively delivering two pieces of reference data of two predetermined reference blocks in a search region, the search region containing the corresponding reference blocks of the data fetching unit, the two predetermined reference blocks being adjacent to each other.

5. The motion estimation device with pipeline architecture according to claim 1, wherein each of the data fetching unit comprises:
a first register for sequentially storing the current data of the current block, the first register of one data fetching unit being coupled to the first register of another data fetching unit.

6. The motion estimation device with pipeline architecture according to claim 1, wherein each of the data fetching unit comprises:
a second register for sequentially storing the reference data of the corresponding reference block of each processing unit.

7. The motion estimation device with pipeline architecture according to claim 1, wherein
for the current block and a corresponding reference block, the match value is a sum of absolute differences between the current data and the corresponding reference data, and
each of the processing units comprises:
a subtractor for calculating an absolute difference between a piece of current data and a piece of reference data; and
an adder for accumulating the calculated results of the subtractor so as to generate the sum of absolute differences.

8. The motion estimation device with pipeline architecture according to claim 1, wherein the motion vector generation unit comprises:
a comparison circuit for obtaining a minimum value from the match values; and
a motion vector generator for generating the motion vector according to the comparison results of the comparison circuit.

9. The motion estimation device with pipeline architecture according to claim 8, wherein the comparison circuit comprises:
a register for storing a temporary minimum value;
a comparator for comparing the temporary minimum value with one of the match values; and
a multiplexer for providing the minor one of the temporary minimum value and the one of the match values to the register according to comparison result of the comparator, so as to update the stored content of the register.

10. A motion estimation system with pipeline architecture, comprising:
a first processing unit array for generating a plurality of first match values, each of the first match values indicating the match degree between a first current block and a corresponding first reference block;
a second processing unit array for generating a plurality of second match values, each of the second match values indicating the match degree between a second current block and a corresponding second reference block, wherein the second current block is adjacent to the first current block, and the corresponding first reference block is adjacent to the corresponding second reference block;
a combination unit for generating a plurality of combination values according to the corresponding sums of the first match values and the second match values, each of the combination values indicating the match degree between a combination current block and a corresponding combination reference block, wherein the combination current block contains the first current block and the second current block which are adjacent to each other, and the combination reference block contains the first reference block and the second reference block which are adjacent to each other; and
a motion vector generation unit for generating a motion vector from the combination current block and a combination reference block which corresponds to optimum match degree according to the combination values.

11. The motion estimation system with pipeline architecture according to claim 10, further comprising:
a third processing unit array for generating a plurality of third match values, each of the third match values indicating the match degree between a third current block and a corresponding third reference block, wherein the third current block is adjacent to the combination current block;
wherein the combination unit generates the combination values according to the corresponding sums of the first match values, the second match values, and the third match values, the combination current block further contains the third current block, and the combination reference block further contains the third reference block.

12. The motion estimation system with pipeline architecture according to claim 10, wherein the first processing unit array comprises:
a plurality of data fetching units, each for fetching a plurality of first current data of the first current block and a plurality of first reference data of the corresponding first reference block; and
a plurality of processing units coupled to the data fetching unit correspondingly, each for processing the first current data and the corresponding first reference data, so as to generate the first match values.

13. The motion estimation system with pipeline architecture according to claim 12, wherein the first current block and the first reference block each have a dimension of n×n, the number of the data fetching units is n+1, and the number of the processing units is n+1.

14. The motion estimation system with pipeline architecture according to claim 13, wherein n is 4.

15. The motion estimation system with pipeline architecture according to claim 12, wherein each of the data fetching units comprises:
a multiplexer for selectively delivering two pieces of reference data of two predetermined reference blocks in a search region, the search region containing the corresponding first reference blocks of the data fetching unit of the first processing unit array, the two predetermined reference blocks being adjacent to each other.

16. The motion estimation system with pipeline architecture according to claim 12, wherein each of the data fetching unit comprises:
a first register for sequentially storing the current data of the current block, wherein the first registers of the data fetching units are coupled in series.

17. The motion estimation system with pipeline architecture according to claim 12, wherein each of the data fetching unit comprises:
a second register for sequentially storing the reference data of the corresponding first reference block of each processing unit.

18. The motion estimation system with pipeline architecture according to claim 12, wherein
for the first current block and a corresponding first reference block, the first match value is a sum of absolute differences between the first current data and the corresponding first reference data, and
each of the processing units comprises:
a subtractor for calculating an absolute difference between a piece of first current data and a piece of first reference data; and
an adder for accumulating the calculated results of the subtractor so as to generate the sum of absolute differences.

19. The motion estimation system with pipeline architecture according to claim 10, wherein the motion vector generation unit comprises:
a comparison circuit for obtaining a minimum value from the combination values; and
a motion vector generator for generating the motion vector according to the comparison results of the comparison circuit.

20. The motion estimation system with pipeline architecture according to claim 19, wherein the comparison circuit comprises:
a register for storing a temporary minimum value;
a comparator for comparing the temporary minimum value with one of the match values; and
a multiplexer for providing the minor one of the temporary minimum value and the one of the match values to the register according to comparison result of the comparator, so as to update the stored content of the register.
